(19) United States
(12) Patent Application Publication
(10) Pub. No.: US 2018/0237084 A1
(43) Pub. Date: Aug. 23, 2018

(54) CUSHION DEVICE FOR TRACK LOADER AND TRACK LOADER HAVING SAME

(71) Applicant: Deere & Company, Moline, IL (US)

(72) Inventors: Yoon Tae NAM, Busan (KR); Chul Hyeon JO, Busan (KR)

(21) Appl. No.: 15/756,511

(22) PCT Filed: Oct. 30, 2015
(86) PCT No.: PCT/KR2015/011588

§ 371 Date: Feb. 28, 2018

(30) Foreign Application Priority Data
Aug. 31, 2015 (KR) 10-2015-0122522

(51) Int. Cl. B62D 55/108; B62D 55/06

(52) U.S. Cl. CPC B62D 55/1086; E02F 3/3414; B62D 55/06

(57) ABSTRACT

A suspension device for a track loader and a track loader having the same are provided that are capable of releasing the shocks applied to a body and minimizing the pitching of the body generated during the work and driving of the track loader to prevent the body from being damaged, reducing a driver's fatigue, and enhancing the workability and rising comfort of the track loader.

### TECHNICAL FIELD

The present invention relates to a suspension device for a track loader and a track loader having the same, and more particularly, to a suspension device for a track loader and a track loader having the same that are capable of preventing a track loader body from being damaged, reducing a driver's fatigue while the track loader is being driven, and enhancing riding comfort and workability of the track loader.

### BACKGROUND ART

A track loader has a bucket, and using the bucket, accordingly, the track loader performs a variety of work such as excavation, soil castle building, soil preparation, and soil, sand or gravels transferring and loading.

Accordingly, the track loader is used widely in various sites of construction, civil engineering, aggregate collection, and the like.

On the other hand, the track loader is driven by means of bogies using caterpillar tracks, so that the track loader is usually driven on severe hills or rough places, rather on flat places, which causes lots of shocks to be continuously applied to the track loader body while the track loader is being driven or working.

As a result, a driver's fatigue becomes seriously increased, and also, damages frequently occur on the track loader body.

So as to remove the above-mentioned problems, there is proposed a suspension device for a track loader which is disclosed in Korean Patent Application Laid-open No. 10-2008-0049524 (Dated on Jun. 4, 2008).

The conventional suspension device for a track loader has a rectangular bar disposed in a rectangular tube connected to a cabin, that is, a body of the track loader, and rubber disposed around the rectangular bar to absorb shocks, wherein the rectangular bar is connected to one side edge of an arm, and an axle is disposed on the other side of the arm in such a manner as to be connected to a frame of an undercarriage, that is, a bogie frame.

According to the conventional suspension device for the track loader, the shocks applied to the body of the track loader, while the track loader is being driven or working, are transmitted just to the rectangular bar via the axle and arm, and after that, the shocks are released during the rectangular bar and the rubber come into contact with each other, thereby allowing the fatigue of the driver to be reduced and minimizing the damages of the body.

According to the conventional suspension device for the track loader, however, when the axle is coupled to the track loader body through the connection with a bracket, it becomes distant from the bucket so as to prevent the interference between the bracket and the bogie frame, thereby undesirably losing the balance of the system.

As a result, stopping, starting, and bucket elevating of the track loader are all carried out unstably, thereby causing the track loader body to be seriously vibrated and lowering the workability and riding comfort thereof.

On the other hand, another suspension device for a track loader is disclosed in Korean Patent No. 10-1519208 (Issued on May 11, 2015) as filed by the same applicant as the invention.

According to the prior suspension device as filed by the same applicant as the invention, through the contacts between protruding plates and buffering members within openings formed in a link housing, the shocks applied to the body while the track loader is being driven or working can be stably released, thereby reducing a driver's fatigue, minimizing the damages of a track loader body, and enhancing the workability and rising comfort of the track loader.

According to the prior suspension device as filed by the same applicant as the invention, as shown in FIG. 10, an axle 20′ connected to the body and an axle 20′ connected to the bogie frame on the link housing mounted on the front side of the bogie frame are disposed up, down, left and right in the opposite direction to an axle 20′ connected to the body and an axle 20′ connected to the bogie frame on the link housing mounted on the rear side of the bogie frame, so that the link housing mounted on the front side of the bogie frame rotates in the opposite direction to the rotating direction of the link housing mounted on the rear side of the bogie frame, thereby increasing the pitching of the body generated during the driving and work of the track loader to cause the workability and rising comfort of the track loader to be lowered.

Accordingly, there is a definite need for development of a suspension device for a track loader capable of stably releasing the shocks applied to the track loader body and minimizing the pitching of the track loader body during the work and driving of the track loader. Up to now, however, no results for satisfying such need have been suggested.

### DISCLOSURE

### Technical Problem

Accordingly, the present invention has been made in view of the above-mentioned problems occurring in the prior art, and it is an object of the present invention to provide a suspension device for a track loader and a track loader having the same that are capable of solving the problems that the link housing mounted on the front side of the bogie frame rotates in the opposite direction to the rotating direction of the link housing mounted on the rear side of the bogie frame, thereby increasing the pitching of the body generated during the driving and work of the track loader to cause the workability and rising comfort of the track loader to be lowered.

### Technical Solution

To accomplish the above-mentioned object, according to a first aspect of the present invention, there is provided a suspension device for a track loader, the device including: a link housing having a pair of axis holes spaced apart from each other in left and right directions thereof and a plurality of openings formed radially along each axis hole; a pair of axles insertedly fitted to the link housing, one axle being connected to a body of the track loader and the other axle being connected to a bogie frame; a pair of covers insertedly fitted to the link housing in the opposite direction to the insertion direction of the pair of axles so as to fix the pair of axles thereto; and a plurality of buffering members insertedly fitted to the openings to release shocks through the contacts with the axles, wherein the suspension device is mounted on the front and back sides of each of the bogie frames disposed on the left and right sides of the body, respectively, and the axle connected to the body and the axle connected to the bogie frame on the link housing mounted on the front side of the bogie frame are disposed in the same direction as the axle connected to the body and the axle connected to the bogie frame on the link housing mounted on the rear side of the bogie frame, so that the link housing mounted on the front side of the bogie frame rotates in the same direction as the link housing mounted on the rear side of the bogie frame.

According to the present invention, preferably, the openings are formed by means of partition walls radially formed along each axis hole.

According to the present invention, preferably, each axis hole has a bush disposed therein.

According to the present invention, preferably, each axle includes a circular plate, a center axis formed on the center of one surface of the circular plate, and a plurality of protruding plates formed radially along the center axis.

According to the present invention, preferably, the center axis has a spiral formed on the front end outer peripheral surface thereof.

According to the present invention, preferably, the pair of axles is disposed in such a manner where one axle and the other axle are opposed to each other with respect to the axis holes and the openings.

According to the present invention, preferably, each cover has a coupling hole formed on the center thereof and a plurality of insertion slots formed radially around the coupling hole.

According to the present invention, preferably, each cover is coupled to each axle by fastening a nut to the front end peripheral surface of the center axis of each axle passing through the coupling hole formed on the center thereof.

According to the present invention, preferably, the buffering members are made of an elastomer.

To accomplish the above-mentioned object, according to a second aspect of the present invention, there is provided a track loader has a suspension device, the device including: a link housing having openings spaced apart from each other in left and right directions thereof; axles inserted into the openings, one axle being connected to a body of the track loader and the other axle being connected to a bogie frame; covers adapted to fix the axles insertedly fitted to the openings; and a plurality of buffering members insertedly fitted to the openings to release shocks through the contacts with the axles, wherein the link housing is mounted on the front and back sides of each of the bogie frames disposed on the left and right sides of the body, respectively, and the axle connected to the body and the axle connected to the bogie frame on the link housing mounted on the front side of the bogie frame are disposed in the same direction as the axle connected to the body and the axle connected to the bogie frame on the link housing mounted on the rear side of the bogie frame, so that the link housing mounted on the front side of the bogie frame rotates in the same direction as the link housing mounted on the rear side of the bogie frame.

According to the present invention, the suspension device for a track loader and the track loader having the same according to the present invention are configured wherein the buffering members and the protruding plates are insertedly fitted to the openings, so that through the contacts between the protruding plates and the buffering members within the openings, the shocks applied to the body during the work and driving of the track loader can be stably released, thereby reducing the fatigue of the driver, minimizing the damages of the body, and enhancing the workability and rising comfort of the track loader.

Additionally, the suspension device for a track loader and the track loader having the same according to the present invention are configured wherein the link housing mounted on the front side of the bogie frame rotates in the same direction as the link housing mounted on the rear side of the bogie frame, so that the pitching of the body generated during the work and driving of the track loader can be minimized, thereby more enhancing the workability and rising comfort of the track loader.

### DESCRIPTION OF DRAWINGS

FIG. 1 is a perspective view showing an outer shape of a suspension device for a track loader according to the present invention.

FIG. 2 is an exploded perspective view showing the suspension device for a track loader according to the present invention.

FIG. 3 is an exploded perspective view showing the suspension device for a track loader according to the present invention, which is viewed in a different direction from that in FIG. 2.

FIG. 4 is a partial sectional view showing the installation of buffering members in the suspension device for a track loader according to the present invention.

FIG. 5 is a perspective view showing an outer shape of a bogie frame to which the suspension device for a track loader according to the present invention is applied.

FIG. 6 is a plan view showing the configuration of the bogie frame to which the suspension device for a track loader according to the present invention is applied.

FIG. 7 is an exemplary view showing the installation of the suspension device for a track loader according to the present invention.

FIG. 8 is an exemplary view showing a track loader to which the suspension device for a track loader according to the present invention is applied.

FIG. 9 is a graph showing the comparison for the vibrations by section of the track loader with the suspension device for a track loader according to the present invention, a track loader with a prior suspension device, and a track loader with no suspension device.

FIG. 10 is an exemplary view showing the installation of link housings in a prior suspension device for a track loader.

### DETAILED DESCRIPTION

Hereinafter, an explanation on a suspension device for a track loader according to the present invention will be in detail given with reference to the attached drawings.

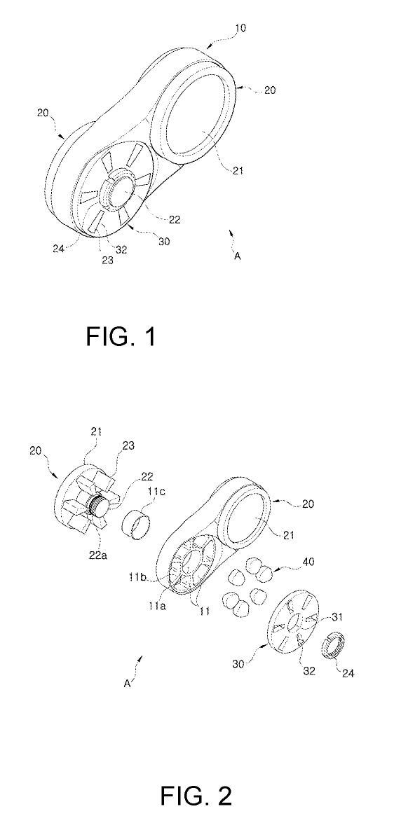

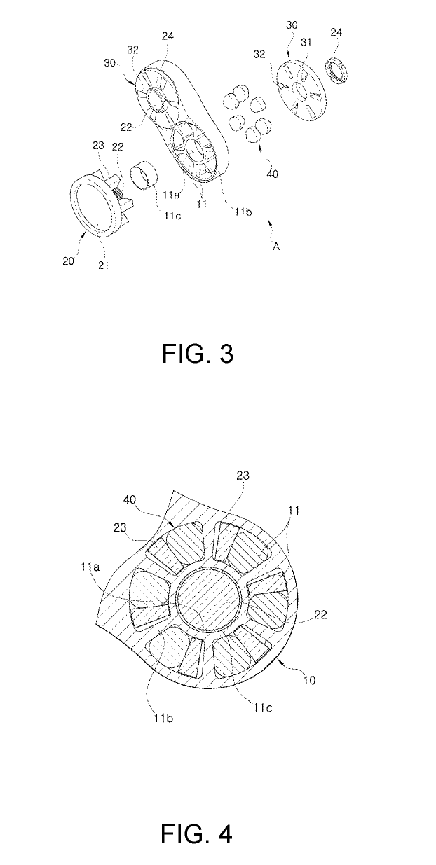

As shown in FIGS. 1 to 3, a suspension device A for a track loader according to the present invention includes a link housing 10, a pair of axles 20, a pair of covers 30, and a plurality of buffering members 40.

The link housing 10 has a pair of axis holes 11a spaced apart from each other in left and right directions thereof and a plurality of openings 11 formed radially along each axis hole 11a.

At this time, the openings 11 are formed by means of partition walls 11b radially formed along each axis hole 11a.

As the openings 11 are formed by means of the partition walls 11b, a plurality of protruding plates 23 of each axle 20 and the plurality of buffering members 40, are insertedly fitted to the openings 11 in such a manner as to be separable from each other.

In this case, each axis hole 11a has a bush 11c insertedly disposed therein.

Through the formation of the bush 11c in each axis hole 11a, the axis hole 11a comes into close contact with a center axis 22 of each axle 20 insertedly fitted to the axis hole 11a.

The pair of axles 20 is inserted into the link housing 10. At this time, as shown in FIG. 8, one axle 20 is connected to a body 100 of the track loader and the other axle 20 to a bogie frame 200.

Each axle 20 includes a circular plate 21, the center axis 22 formed on the center of one surface of the circular plate 21, and the plurality of protruding plates 23 formed radially along the center axis 22.

Through the formation of the center axis 22 on each axle 20, the center axis 22 is inserted into the axis hole 11a so that each axle 20 is connected to the link housing 10.

At this time, the center axis 22 desirably has a spiral 22a formed on the outer peripheral surface of the front end surface thereof.

Through the formation of the spiral 22a on the center axis 22, in the state wherein the center axis 22 is passed through a coupling hole 31 formed on each cover 30 as will be discussed later, a spiral (with no reference numeral) formed on the inner peripheral surface of a nut 24 is engaged with the spiral 22a, so that each axle 20 and each cover 30 are coupled to each other.

The pair of axles 20 is disposed in such a manner where one axle 20 and the other axle 20 are opposed to each other with respect to the axis holes 11a and the openings 11.

That is, one axle 20 whose one surface, on which the center axis 22 is formed, is inserted forwardly from the rear sides of the axis hole 11 and the openings 11 thereof, and the other axle 20 whose one surface, on which the center axis 22 is formed, is inserted backwardly from the front sides of the axis hole 11 and the openings 11 thereof.

Through the insertion of the pair of axles 20 in such a manner where one axle 20 and the other axle 20 are opposed to each other with respect to the axis holes 11a and the openings 11, the rear surface of the circular plate 21 is fixed to the body 100 or the bogie frame 200, so that one axle 20 is connected to the body 100 and the other axle 20 to the bogie frame 200.

At this time, a method for fixing the pair of axles 20 to the body 100 and the bogie frame 200 does not matter only if the fixed state is rigidly maintained through the method. For example, the fixing is achieved by means of welding.

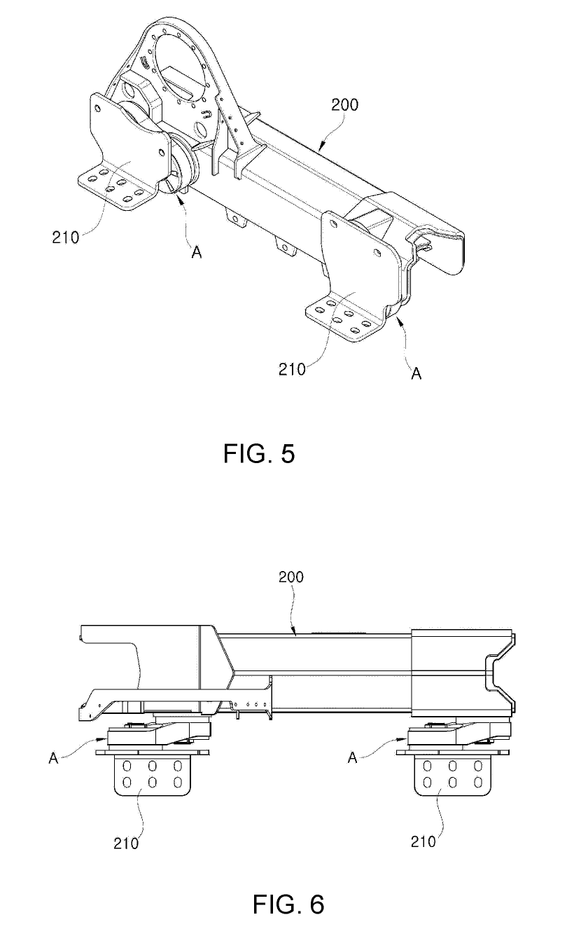

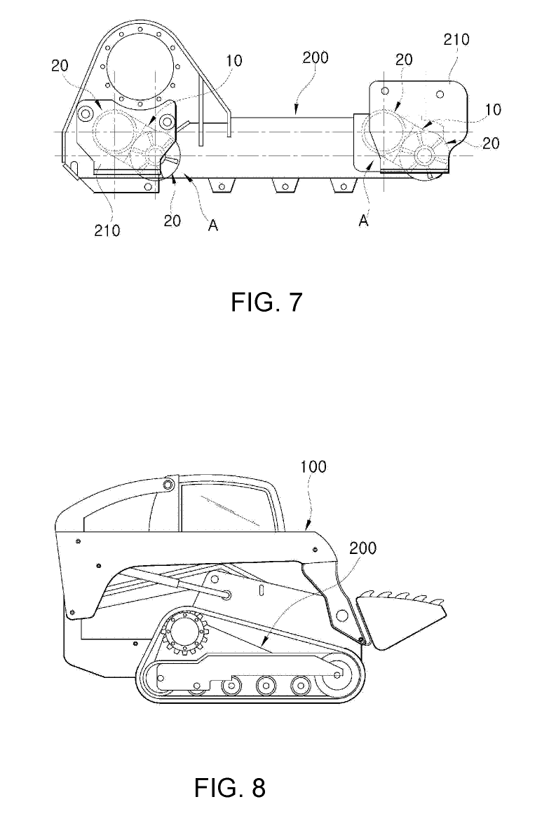

Further, as shown in FIGS. 5 and 6, the axle 20 connected to the body 100 is coupled to a bracket 210, so that the bracket 210 is fixed to the body 100, thereby connecting the body 100 and the axle 20 to each other.

The pair of covers 30 is insertedly fitted to the link housing 10 in the opposite direction to the insertion direction of the pair of axles 20, thereby fixing the pair of axles 20 thereto.

Each cover 30 has the coupling hole 31 formed on the center thereof and the plurality of insertion slots 31 formed radially along the coupling hole 31.

Through the formation of the coupling hole 31 on each cover 30, the nut 24 is fastened to the front end periphery of the center axis 22 of each axle 20 passing through the coupling hole 31, so that each cover 30 is coupled to each axle 20.

Through the formation of the insertion slots 32 on each cover 30, further, the protruding plates 23 are inserted into the insertion slots 32 so that each cover 30 moves by means of the movement of each axle 20, thereby allowing the coupled state between each axle 20 and each cover 30 to be continuously maintained rigidly.

The buffering members 40 are insertedly fitted to the openings 11 in such a manner as to come into contact with the axle 20 to release the shocks applied to the axle 20.

The buffering members 40 are desirably made of an elastomer.

If the buffering members 40 are made of the elastomer, through the characteristics of the elastomer, they can stably buffer the shocks generated when coming into contact with the protruding plates 23.

The buffering members 40 are disposed on both sides of the interiors of the openings 11 or on any one side thereof.

If the buffering members 40 are disposed on any one side of the interiors of the openings 11, the protruding plates 23 come into contact with the buffering members 40 when they move only in any one direction of both side directions of the openings 11, thereby releasing the shocks generated upon the contacts.

Contrarily, if the buffering members 40 are disposed on both sides of the interiors of the openings 11, the protruding plates 23 come into contact with the buffering members 40 even though they move in any direction of both side directions of the openings 11, thereby more improving the effects for releasing the shocks generated upon the contacts.

On the other hand, the suspension device A for a track loader according to the present invention is mounted on each of the front and rear sides of the bogie frame 200 disposed on each of the left and right sides of the body 100 of the track loader.

While the track loader is being driven or working, accordingly, the shocks generated in every direction of the body 100 and the bogie frame 200 can be uniformly released.

At this time, the axle 20 connected to the body 100 and the axle 20 connected to the bogie frame 200, on the link housing 10 mounted on the front side of the bogie frame 200, are disposed in the same direction as the axle 20 connected to the body 100 and the axle 20 connected to the bogie frame 200, on the link housing 10 mounted on the rear side of the bogie frame 200, so that the link housing 10 mounted on the front side of the bogie frame 200 rotates in the same direction as the link housing 10 mounted on the rear side of the bogie frame 200, thereby minimizing the pitching of the body 100 caused by the misalignment of the rotating directions of the link housings 10.

Now, an explanation on the shock releasing effect of the suspension device A for the track loader according to the present invention will be in detail given.

The protruding plates 23 of the axles 20 are passed through the openings 11 formed in the link housing 10.

Next, the buffering members 40 are insertedly fitted to the openings 11.

Accordingly, the protruding plates 23 moving within the openings 11 come into contact with the buffering members 40 adjacent thereto, as shown in FIG. 4, so that shocks are released through the contacts between the protruding plates 23 and the buffering members 40.

At this time, the pair of axles 20 is disposed in such a manner where one axle 20 and the other axle 20 are opposed to each other with respect to the axis holes 11a and the openings 11, thereby connecting one axle 20 to the body 100 and connecting the other axle 20 to the bogie frame 200.

Accordingly, if the track loader is driven or works, the body 100 and the bogie frame 200 move, and thus, if the axles 20 connected to them move, the protruding plates 23 and the buffering members 40 within the openings 11 come into contact with each other, so that while the track loader is being driven or working, the shocks applied to the body 100 are released to reduce the fatigue of the driver, minimize the damages of the body 100, and enhance the workability and rising comfort of the track loader.

In this case, if the link housing 10 mounted on the front side of the bogie frame 200 rotates in the different direction from the link housing 10 mounted on the rear side of the bogie frame 200, the workability and rising comfort of the track loader can be decreased due to the pitching of the body 100 generated during the work and driving of the track loader.

According to the present invention, however, the axle 20 connected to the body 100 and the axle 20 connected to the bogie frame 200, on the link housing 10 mounted on the front side of the bogie frame 200, are disposed in the same direction as the axle 20 connected to the body 100 and the axle 20 connected to the bogie frame 200, on the link housing 10 mounted on the rear side of the bogie frame 200, so that the link housing 10 mounted on the front side of the bogie frame 200 rotates in the same direction as the link housing 10 mounted on the rear side of the bogie frame 200.

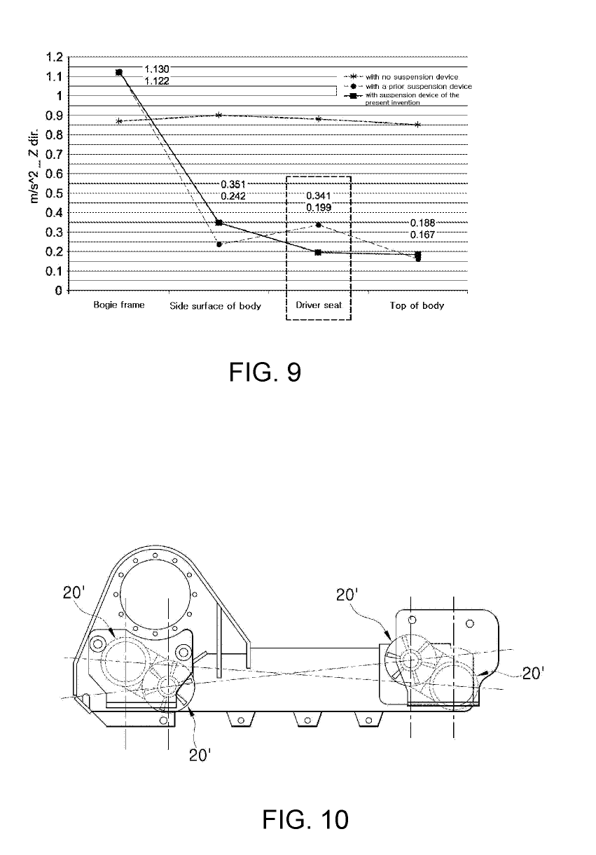

As a result, the pitching of the body 100 caused by the misalignment of the rotating directions of the link housings 10 can be minimized while the track loader is being driven or working. Particularly, as shown in FIG. 9, vibrations generated from a driver's seat can be more reduced by about 70 to 80% than those generated from a driver's seat of the track loader with no suspension device and can be more reduced by about 42% than those generated from a driver's seat of the track loader with the prior suspension device (disclosed in Korean Patent No. 10-1519208), thereby more enhancing the workability and rising comfort of the track loader.

On the other hand, if each axle 20 insertedly fitted to the axis hole 11a and the openings 11 is escaped from the link housing 10, the protruding plates 23 and the buffering members 40 do not come into contact with each other within the openings 11, thereby obtaining no shock releasing effects caused by contacts between the protruding plates 23 and the buffering members 40.

According to the present invention, however, each axle 20 insertedly fitted to the axis hole 11a and the openings 11 has the spiral 22a formed on the front end periphery of the center axis 22 formed on the center of the circular plate 21, so that the front end periphery of the center axis 22 is passed through the coupling hole 31 formed on each cover 30 and is then fastened to the nut 24, thereby allowing the axle 20 to be fixedly insertedly fitted to the axis hole 11a and the openings 11.

Accordingly, the escape of the axle 20 from the link housing 10 is prevented to continuously provide shock releasing effects caused by the contacts between the protruding plates 23 and the buffering members 40 within the openings 11.

As mentioned above, the suspension device A for a track loader and the track loader having the same according to the present invention are configured wherein the buffering members 40 and the protruding plates 23 are insertedly fitted to the openings 11, so that through the contacts between the protruding plates 23 and the buffering members 40 within the openings 11, the shocks applied to the body 100 during the work and driving of the track loader can be stably released, thereby reducing the fatigue of the driver, minimizing the damages of the body 100, and enhancing the workability and rising comfort of the track loader, and they are configured wherein the link housing 10 mounted on the front side of the bogie frame 200 rotates in the same direction as the link housing 10 mounted on the rear side of the bogie frame 200, so that the pitching of the body 100 caused by the misalignment of the rotating directions of the link housings 10 can be minimized, thereby more enhancing the workability and rising comfort of the track loader.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A suspension system for a track loader, comprising:
first and second suspension devices each having
a link housing having a pair of axis holes spaced apart from each other in left and right directions thereof and a plurality of openings formed radially with respect to each axis hole;
a pair of axles fitted to the link housing, one axle being connected to a body of the track loader and the other axle being connected to a bogie frame;
a pair of covers fitted to the link housing in a first direction opposite a second direction of insertion of the pair of axles so as to fix the pair of axles thereto; and
a plurality of buffering members fitted to the openings to absorb shocks,
wherein the first and second suspension devices are mounted on the front and back sides of the bogie frame, and the axle connected to the body and the axle connected to the bogie frame on the link housing mounted on the front side of the bogie frame are disposed in the same direction as the axle connected to the body and the axle connected to the bogie frame on the link housing mounted on the rear side of the bogie frame, so that the link housing mounted on the front side of the bogie frame rotates in the same direction as the link housing mounted on the rear side of the bogie frame.

2. The suspension system for a track loader according to claim 1, wherein the openings of each link housing are formed by means of partition walls radially formed along each axis hole.

3. The suspension system for a track loader according to claim 2, wherein each axis hole of at least one of the link housings has a bush disposed therein.

4. The suspension system for a track loader according to claim 1, wherein each axle comprises a circular plate, a center axis formed on the center of one surface of the circular plate, and a plurality of protruding plates formed radially along the center axis.

5. The suspension system for a track loader according to claim 4, wherein the center axis has a spiral formed on the front end outer peripheral surface thereof.

6. The suspension system for a track loader according to claim 1, wherein the pair of axles of each suspension device is disposed in such a manner that the pair of axles are opposed to each other with respect to the axis holes and the openings.

7. The suspension system for a track loader according to claim 1, wherein each cover has a coupling hole formed on the center thereof and a plurality of insertion slots formed radially around the coupling hole.

8. The suspension system for a track loader according to claim 7, wherein each cover is coupled to each axle by fastening a nut to the front end peripheral surface of the center axis of each axle passing through the coupling hole formed in the center thereof.

9. The suspension system for a track loader according to claim 1, wherein the buffering members are made of an elastomer.

10. A track loader having the suspension system for a track loader as claimed in claim 1.
